(19) United States
(12) Patent Application Publication
(10) Pub. No.: US 2012/0126091 A1
(43) Pub. Date: May 24, 2012

(54) DEVICE FOR SUSPENDING AN OSCILLATING LOAD, PARTICULARLY FOR AN EXHAUST GAS SYSTEM OF A MOTOR VEHICLE

(75) Inventors: Klaus Kleindorfer, Kraiburg am Inn (DE); Klaus Steinmaier, Kraiburg am Inn (DE); Alexander Latz, Waldkraiburg (DE)

(73) Assignee: SGF SUEDDEUTSCHE GELENKSCHEIBENFABRIK GMBH & CO. KG, Waldkraiburg (DE)

(21) Appl. No.: 13/388,594

(22) PCT Filed: Aug. 4, 2010
(86) PCT No.: PCT/EP2010/004787

§ 371 Date: Feb. 2, 2012

(30) Foreign Application Priority Data
Aug. 10, 2009 (DE) 10 2009 036 869.8

(51) Int. Cl. B60K 13/04

(52) U.S. Cl. 248/674

(57) ABSTRACT

The invention relates to a device for suspending an oscillating load, particularly for an exhaust gas system of a motor vehicle, having an elastomer body sealed in a ring shape and comprising two receptacle openings located opposite one another for accommodating one longitudinal suspension bolt each along a longitudinal axis of each receptacle opening, wherein the elastomer body is designed to deform elastically in the event of oscillations introduced via the receptacle openings. According to the invention at least one of the receptacle openings is designed with at least one section that broadens relative to the longitudinal axis towards the end of the receptacle opening.

### TECHNICAL FIELD

The invention relates to a device for suspending an oscillating load, particularly for an exhaust system of a motor vehicle, having an elastomer body which is of closed ring shape and has two receiving openings located opposite one another for receiving a respective elongate suspending bolt along a respective longitudinal axis of the receiving openings, the elastomer body being designed for elastic deformation in the event of oscillations introduced via the receiving openings.

### BACKGROUND OF RELATED ART

A device of this kind is already known from the prior art. For instance, the document WO 99/48717 discloses such a device for suspending an exhaust system of a motor vehicle from a motor vehicle chassis. In this case, a cylindrical suspending bolt on the chassis side is inserted into the upper receiving opening of the suspending device. The suspending bolt on the exhaust system side is inserted into the lower receiving opening of the device. During operation of the motor vehicle, in this case particularly vertical oscillations of the exhaust system in relation to the vehicle chassis which are caused by roadway excitation can be absorbed and damped, i.e. oscillations along the Z-direction according to the prior art cited above.

It has been found, however, that oscillations in the Y-direction, i.e. along the longitudinal axis of the receiving openings, can be absorbed and damped only unsatisfactorily owing to the relatively high Y-stiffness of the suspending device previously known from the prior art. In the case of such oscillations in the Y-direction there is fundamentally a conflict situation. On the one hand, the stiffness in this Y-direction is to be relatively high. This stems from the fact that undesired striking of components of the exhaust system against other motor vehicle components is absolutely to be prevented. For design reasons, modern motor vehicles often have rear aprons with openings, through which the tailpipes of the exhaust system are passed. These openings are designed relatively narrow and with little clearance from the tailpipe, thus exacerbating the problem of avoiding undesired contacts with the tailpipe of the exhaust system. On the other hand, the stiffness in the Y-direction is to be low, in order to be able to decouple oscillations of small amplitude sufficiently and thereby accordingly avoid the introduction of structure-borne noise into the vehicle body.

A number of further devices for elastic suspension of exhaust systems are known from the prior art. Examples of these are disclosed in the documents EP 0 710 769 A2, DE 41 39 381 A1, DE 26 58 358 A1 and DE 37 37 981 A1. Nor do these documents contain any proposals for effectively dealing with the conflict of aims outlined above regarding the Y-stiffness.

By contrast, it is an object of the present invention to provide a device of the kind described in the introduction, with which the conflict of aims outlined above of setting a suitable Y-stiffness can be achieved.

### SUMMARY

This object is achieved by a device of the kind described in the introduction, in which it is provided that at least one of the receiving openings is designed with at least one section which widens with respect to the longitudinal axis towards the end of the receiving opening.

The solution according to the invention creates between the device and the suspending bolts received in the receiving openings a certain freedom of movement which provides a Y-stiffness with a soft zero crossing in the event of oscillations in the Y-direction. At a relatively low Y-amplitude, i.e. with low roadway excitation, the device according to the invention can move in pendulum fashion relatively freely in the Y-direction by virtue of the at least one widening section. This is because with low roadway excitation and thus acoustically sensitive driving, the exhaust system hangs substantially perpendicularly under the vehicle. Owing to the engine excitation, the exhaust system performs relatively high-frequency oscillations with low amplitude (<1 mm). These high-frequency oscillations can, according to the invention, be so sufficiently damped, i.e. decoupled from the vehicle body, by virtue of the ability to move in pendulum fashion at low amplitude in the Y-direction. This is achieved by the soft zero crossing of the characteristic curve achieved according to the invention.

With high roadway excitation, in contrast, the exhaust system is greatly accelerated in the is direction of the Y-direction, i.e. parallel to the longitudinal axis of the receiving openings, which would lead to comparatively large amplitudes. However, with increasing amplitude the device according to the invention becomes stiffer in the Y-direction, so that the oscillating displacements at such lame accelerations can be sufficiently limited. In such a situation with large amplitudes in the Y-direction, the respective suspending bolt at a certain deflection comes into close contact with the wall of the widening section of the receiving opening again. A defined limit is thus set to the amplitude of the pendulum movement. The introduction of oscillations into the chassis which then takes place is no longer disturbing in such driving situations, since the noise level in the vehicle is already relatively high owing to the high roadway excitation, for example in the event of an extreme driving manoeuvre.

A development of the invention provides that the widening section is formed at least in sections by the lateral surface of a truncated cone, of a hyperboloid of revolution, of a paraboloid of revolution, or of a further widening body of revolution with respect to a revolution about the longitudinal axis of the respective receiving opening. A suitable geometry is to be chosen, depending on the particular application and desired setting of the characteristic curve. If, for example, the lateral surface in the shape of a truncated cone is chosen, there results a clear delimitation between permissible pendulum movement and limiting of the amplitude. If a lateral surface in the shape of a hyperboloid of revolution is chosen, in contrast, there results a smooth transition by virtue of the rounded surface course.

A development of the invention provides that the widening section has merely segmental widening regions, when viewed in the direction of the longitudinal axis of the receiving opening. This means that in the widening section the receiving opening does not widen over its entire circumference with respect to the longitudinal axis, but merely in partial segments. As a result, the direction of the pendulum movements can be clearly defined. Pendulum movements at right angles to the Y-direction can, for example, be suppressed thereby. In this connection, it can be provided that the widening segments are arranged, when viewed in the direction of the longitudinal axis of the receiving opening, around a vertical axis (Z-axis) running at right angles to the longitudinal axis and running parallel with respect to a first reference plane containing both longitudinal axes of the receiving openings, or part of this reference plane. A further advantage of this solution is that, when using headed bolts, undesired slipping of the bolt out of the receiving opening is made more difficult owing to the fact that the sections of the receiving opening which widen in diameter remain in close contact with the bolt over its entire length and thereby engage behind the head of the bolt in the same way as is the case in the prior art without widening sections. Unintended detachment of the bolt from the receiving opening is thereby made more difficult.

A development of the invention provides that the at least one receiving opening is designed, at each of its two opposite ends, with a section widening in the direction of the longitudinal axis towards the respective end of the receiving opening. As a result, it is possible for the device according to the invention to be mounted any way with respect to the suspending bolts. Moreover, the pendulum behaviour is symmetrical. In order to provide a defined rest position, it can further be provided according to the invention that a substantially circular-cylindrical section running in the direction of the longitudinal axis is provided between two widening sections, arranged at the ends, of a receiving opening. The length of this circular-cylindrical section in which the respective suspending bolt is tightly received can again be chosen according to the desired course of the characteristic curve. In principle, pendulum movements are more strongly suppressed with a greater length of the substantially circular-cylindrical section and shorter design of the widening sections than if a relatively short length of the circular-cylindrical section and comparatively longer widening sections of the receiving openings are chosen. Furthermore, in this connection, it can be provided according to the invention that the transition between the at least one section widening towards the end of the receiving opening and the adjoining circular-cylindrical section is of rounded design or designed with a transition bevel. By this means too, smooth transitions in the damping characteristic curve can be achieved.

A development of the invention provides that the at least one section widening in the direction of the longitudinal axis towards the end of the receiving opening is provided with a further diameter narrowing at the end of the receiving opening. The further narrowing of the widening section at the end of the receiving opening can particularly prevent the fastening bolt from being pulled out of the receiving opening in an undesired manner. Such bolts are normally designed with thickenings or mushroom heads at the end, which prevent them from being axially pulled out of the bore. Such narrowings are, however, dimensioned so that they do not hinder the pendulum movement between bolt and suspending device.

According to the invention, it can further be provided that at least one receiving opening is provided in the direction of the longitudinal axis with longitudinal slots arranged in the radially outer region of the device. By locally slotting a circumferential section of the receiving opening, this section can be locally weakened, so that in the event of oscillations occurring the remaining webs on both sides of the slots are locally deformed in a specific manner. In other words, such slots enable easier elastic deformation of the device according to the invention, creating a preferred direction of pendulum movement.

A development of the invention provides that the elastomer body is reinforced with a reinforcing device. In this connection, it can be provided that a flexible reinforcing insert, in particular at least one textile thread bundle, is embedded in the elastomer body. Alternatively to this or additionally, it can also be provided that the elastomer body is surrounded in its radially outer region by a reinforcing band or reinforcing ring.

According to the invention, it can further be provided that the elastomer body has a central opening radially within its region of closed ring shape, a pair of mutually facing, preferably vertical, buffers reaching into the central opening and being arranged between the receiving openings. In this connection, a development of the invention provides that each of the buffers respectively projects radially inwards from an edge region having the receiving openings and has an end face facing the respective other buffer, each of the buffers being laterally connected to the region, of closed ring shape, of the elastomer body via connecting regions. The buffers ensure that, in the event of oscillations in the Z-direction at amplitudes that are too large, a kind of damped stop is provided in the Z-direction.

Furthermore, it can be provided according to the invention that the connecting regions have, at least in sections, a wall thickness reduced in relation to the region, of closed ring shape, of the elastomer body. It has been found that on high loading in the Z-direction forces arise in the elastomer body which are supported at the receiving opening or at the bolt received in the receiving opening. With large forces in the Z-direction, an elastic deformation occurs between bolt and receiving opening, particularly in the regions in which a gap is present between both components in the rest state. The latter is the case particularly in the widening sections. If this gap is closed owing to the high deformation forces, the possibility of a pendulum movement as is to be provided according to the invention is thereby eliminated. Owing to the deformation and closing of the gap, a pendulum movement would therefore no longer be possible. In order to overcome this problem, a development of the invention provides that the force flow in the elastomer body in the region of the widening sections is interrupted. By reducing the wail thickness of the connecting regions in the end region of the elastomer body with respect to the Y-direction (longitudinal axis of the receiving bore), there is no force flow in this end region, so that no deformation of the elastomer body in this region can occur either. As a result, the gap created at the widening sections between fastening bolt and receiving opening is retained, which enables a pendulum movement in the Y-direction to be maintained despite high forces in the Z-direction.

### BRIEF DESCRIPTION OF THE DRAWINGS

The invention is explained below by way of example with reference to the accompanying figures, in which:

FIGS. 1a-1c show a front view, a longitudinal-sectional view, and a perspective view of a first embodiment of the device according to the invention;

FIG. 1d shows a characteristic curve of the device from FIGS. 1a-1c with regard to the oscillating behaviour in the Y-direction;

FIGS. 2a, 2b show a front view and a longitudinal-sectional view of a second embodiment of the device according to the invention;

FIGS. 3a-3c show a front view, a longitudinal-sectional view, and a perspective view of a third embodiment of the device according to the invention;

FIGS. 4a, 4b show a front view and a longitudinal-sectional view of a fourth embodiment of the device according to the invention;

FIGS. 5a-5c show a front view, a longitudinal-sectional view, and a perspective view of a fifth embodiment of the device according to the invention;

FIGS. 6a-6c show a front view, a longitudinal-sectional view, and a longitudinal-sectional view in a loading situation of a sixth embodiment;

FIG. 6d shows a longitudinal-sectional view of a modification of the embodiment from FIGS. 6a-6c;

FIGS. 7a-7c show a front view, a longitudinal-sectional view, and a longitudinal-sectional view in a loading situation of a seventh embodiment;

FIGS. 8a, 8b show a front view and a longitudinal-sectional view of an eighth embodiment;

FIGS. 9a, 9b show a front view and a longitudinal-sectional view of a ninth embodiment;

FIGS. 10a, 10b show a front view and a longitudinal-sectional view of a tenth embodiment; and

FIGS. 11a, 11b show a front view and a longitudinal-sectional view of an eleventh embodiment.

### DETAILED DESCRIPTION

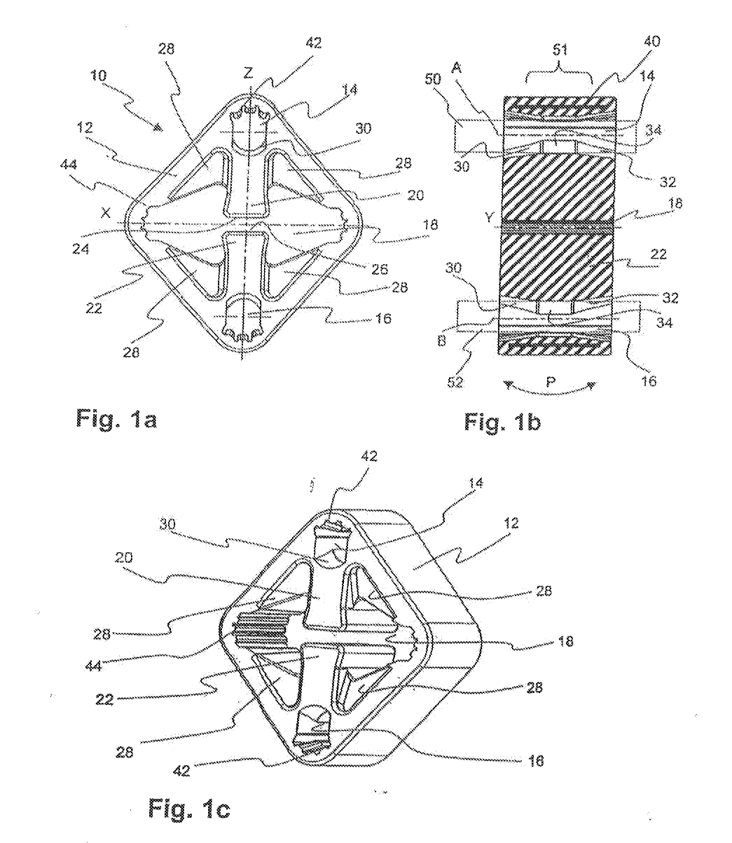

FIGS. 1a to 1c show a first embodiment of the suspending device according to the invention, generally denoted by 10. This device 10 comprises an elastomer body 12 which is of closed ring shape and has at its upper and lower ends in FIG. 1a respective receiving openings 14, 16. The receiving openings 14, 16 have a respective longitudinal axis A, B extending substantially parallel to a Y-axis. The two longitudinal axes A, B intersect a vertical Z-axis. The Y-axis and a horizontal X-axis orthogonal thereto run perpendicular to the Z-axis.

It can be seen that the suspending device 10 has a central opening 18. Owing to the fact that the device 10 according to the invention is formed from elastomer material and a central opening 18 is provided, said device is elastically deformable. In the rest state, the elastomer body 12 of closed ring shape forms a rhombus with rounded corners.

Starting from the upper and lower corner regions, in which the receiving openings 14 and 16 are arranged, two respective buffers 20, 22 extend radially inwards. These buffers 20, 22 are of roughly beam-shaped structure and have mutually facing end faces 24, 26. The two buffers 20, 22 are connected to the rhombus-shaped elastomer body 12 of closed ring shape on both sides in a respective connecting region 28 made of elastomer material. It should be noted, however, that the wall thickness of these connecting regions 28 decreases in each case continuously, starting from the wall thickness of the rhombus-shaped elastomer body 12 of closed ring shape towards the buffers 20, 22. This can be seen particularly in the perspective view according to FIG. 1c.

Turning to the receiving openings 14 and 16, it can be seen that these are not simple cylindrical openings, as known from the prior art, but have a comparatively complicated geometry. In the lower and upper region with respect to the Z-axis, the receiving openings 14, 16 are each provided with segment-shaped, conical sections 30, 32, when viewed in the direction of the Y-axis, which each widen towards the axial end of the receiving openings 14 and 16. The two conical sections 30 and 32 are connected via circular-cylindrical segment sections 34 of constant diameter. This can be seen particularly in the longitudinal-sectional view containing the Z-axis according to FIG. 1b. The lateral vertical surfaces which can be seen in FIGS. 1a to 1c and which connect the upper and lower segment of the conical regions 30 and 32 to one another are of substantial planar form. This can be seen particularly in FIGS. 1a and 1c. Furthermore, in FIG. 1b it can be seen that a thread insert 40 is provided radially outside the receiving openings 14 and 16. This insert is closed and embedded in the elastomer body 12 of closed ring shape.

Finally, it can be seen that longitudinal slots 42 running in the Y-direction are provided in the radially outer region of the receiving openings 14 and 16 around the Z-axis. Furthermore, slots 44 are likewise provided in the horizontal corner regions surrounding the X-axis.

In a mounted position, the receiving opening 14 of the device 10 according to the invention receives a substantially cylindrical receiving bolt on the chassis side, illustrated by a dotted line in FIG. 1b and generally denoted by the reference symbol 50. The receiving opening 16 receives a fastening bolt on the exhaust system side, which is likewise of substantially cylindrical shape and is generally denoted by 52 in FIG. 1b. In the rest position, these bolts each rest tightly on the cylindrical region 34 of the two receiving openings 14 and 16. If, however, oscillations arise between the chassis and the exhaust system in the Y-direction, the bolts can be pivoted out of their position shown in FIG. 1b in the receiving openings 14 and 16, with deformation of said openings, until they come into contact with the conical regions 30 and 32. The deformation of the receiving openings is facilitated by the slots 42. Overall, a defined pendulum movement corresponding to the arrow P of the suspending device 10 is thereby possible, which enables defined deflections of the bolt 52 on the exhaust system side and along with this of the exhaust system (not shown) with respect to the bolt 50 on the chassis side.

In other words, the exhaust system suspension 10 according to the invention acts as a pendulum bearing between the chassis and the exhaust system. The pendulum movements in the Y-direction are defined by the opening angle of the conical regions 30 and 32. As long as the bolts 50, 52 are located within the opening angle of the conical regions 30 and 32, a pendulum movement with relatively low resistance is possible. But as soon as the bolts 50 and 52 come into contact with the conical regions 30 and 32, respectively, as a result of a correspondingly large pendulum amplitude, limits are set to the pendulum movement within the bounds of the elastic deformation of the suspending device 10. A characteristic curve I, shown in FIG. 1d, regarding the force in the Y-direction with respect to the deflecting displacement, with a relatively soft zero crossing is thereby obtained. This means that deflections with relatively small amplitude are possible without substantial resistance, whereto on rising amplitude a considerable increase in force follows. It can also be seen that the characteristic curve I exhibits hysteresis owing to the elastomer material used. Reference symbol II shows the characteristic curve of a conventional suspending device, as described in the introduction with reference to the prior art. The zero crossing of this characteristic curve is substantially steeper than in the present invention, which shows that even oscillations with small amplitudes in the Y-direction cannot be adequately decoupled.

With low roadway excitation and thus acoustically sensitive driving, the exhaust system hangs under the vehicle via the bolt 52, the bolt 52 engaging in the suspending device 10 which, in turn, is attached on the chassis side via the bolt 50. Owing to the engine excitation, the exhaust system performs relatively high-frequency oscillations with low amplitude in the Y-direction. By virtue of the relatively low Y-stiffness at the zero crossing (curve I) according to the invention, these oscillations with small amplitude are not introduced into the vehicle body but are sufficiently decoupled from the vehicle body.

With high roadway excitation, in contrast, the exhaust system is greatly accelerated in the direction of the Y-axis and would reach a correspondingly high amplitude or deflection if no limits were set to this movement. According to the invention, such large oscillation amplitudes can be avoided, since the bolts 50 and 52 come into contact with the conical regions 30 and 32. Accordingly, the characteristic curve I from FIG. 1d becomes steeper with increasing displacement (amplitude).

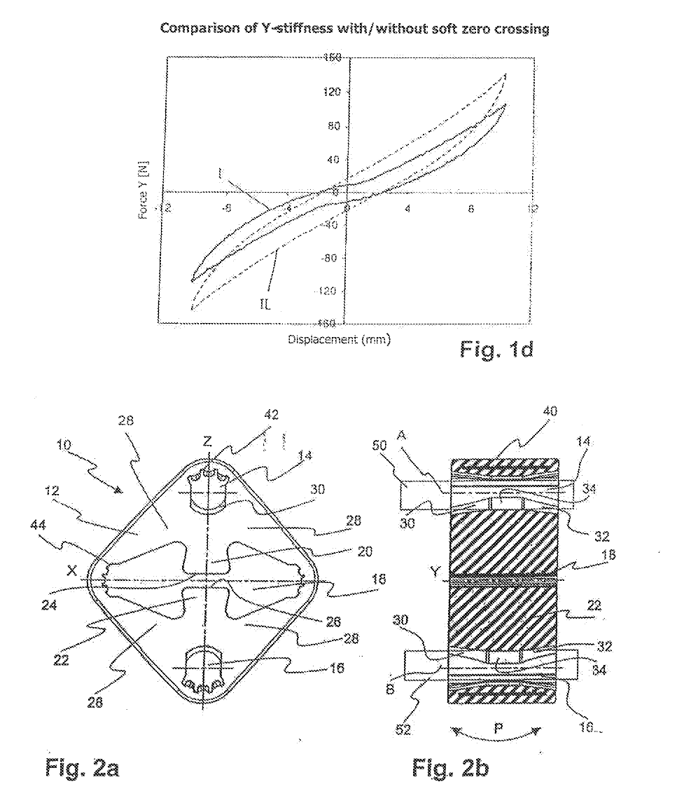

FIGS. 2a and 2b show an embodiment which is slightly modified in relation to FIG. 1 and differs from the embodiment according to FIGS. 1a to 1c in that the connecting regions 28 are not reduced in their wall thickness with respect to the buffers 20, 22.

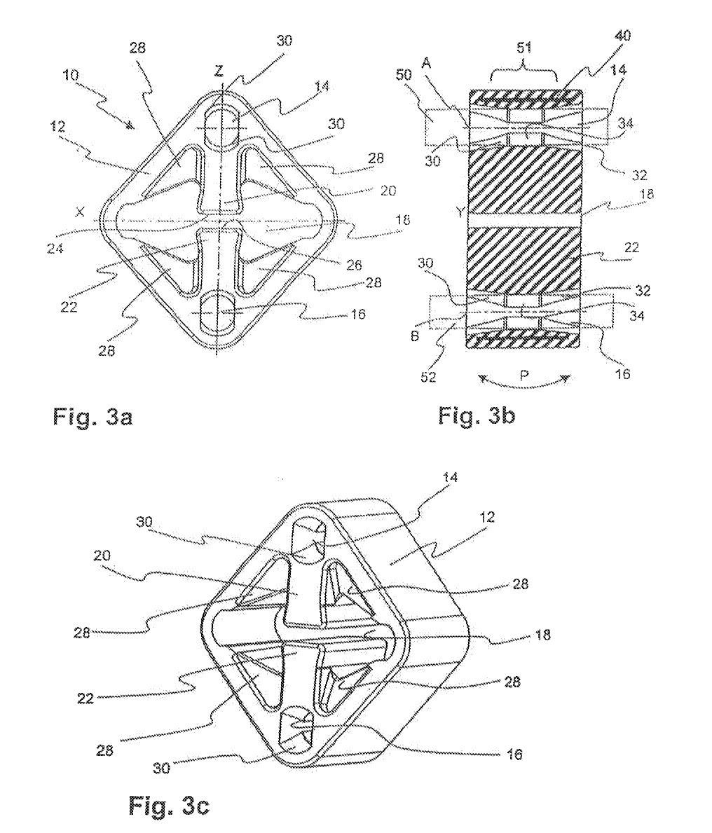

The embodiment according to FIGS. 3a to 3c is substantially the same as the embodiment according to FIGS. 1a to 1c. However, the slots 42 and 44 have been omitted in the embodiment according to FIGS. 3a to 3c.

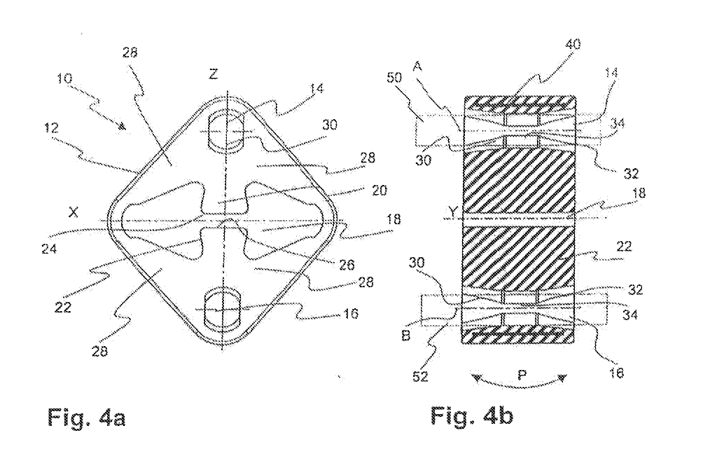

The embodiment according to FIGS. 4a and 4c is similar to the embodiment according to FIGS. 2a and 2c, with the slots 42 and 44 again having been omitted. In both the embodiments according to FIGS. 3a to 3c and 4a, 4b, it can be seen that the receiving openings 14 and 16 have conically widening sections 30 and 32 only in their upper and lower segments surrounding the Z-axis. The vertical regions remote from the Z-axis are formed by substantially parallel plane surfaces, so that the receiving openings 14 and 16 do not widen in the X-direction. In this way, on reception of a headed bolt, these regions remote from the Z-axis engage behind the head and undesired slipping of the headed bolt out of one of the receiving openings 14 and 16 can be effectively prevented.

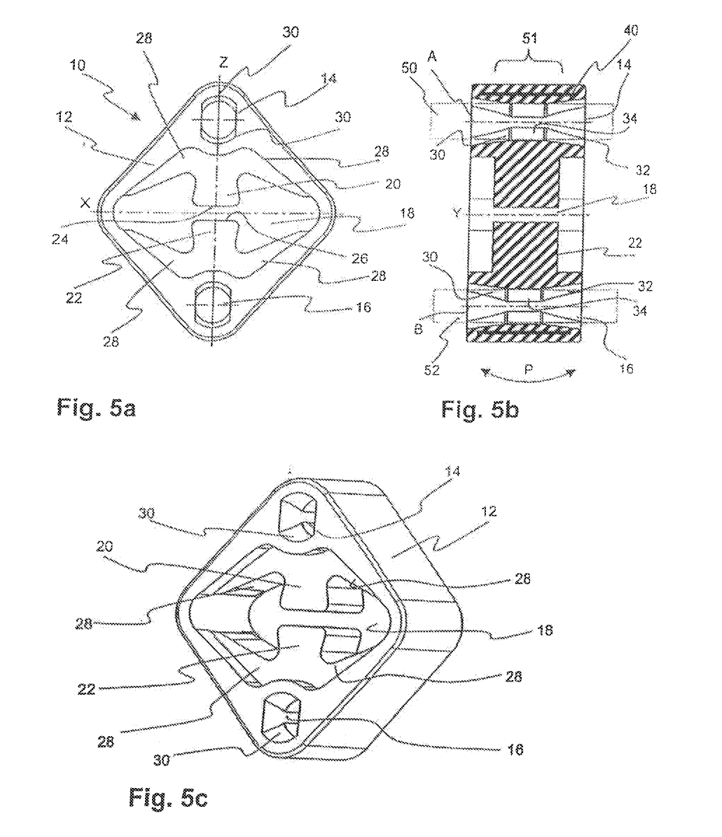

FIGS. 5a to 5c is an embodiment similar to the illustration according to FIGS. 3a to 3c, but in which the buffers 20, 22 also have reduced wall thickness.

The reduction of the wall thickness in the region of the connecting regions 28 according to FIGS. 1a to 1c, 3a to 3c and 5a to 5c has the effect that the force flow under Z-loading in the elastomer body 12 around the end sections of the receiving openings 14 and 16 is interrupted and concentrated on the central region 51 of the receiving openings 14 and 16. This ensures that no deformations can take place in the end regions of the receiving openings 14 and 16, i.e. where said openings widen to ensure the pendulum movement. As a result, the gap, required for the pendulum movement, between the bolts 50 and 52 and the receiving openings 14 and 16 in order to maintain the possibility for pendulum movement also under high loading of the suspending device 10 in the Z-direction is retained.

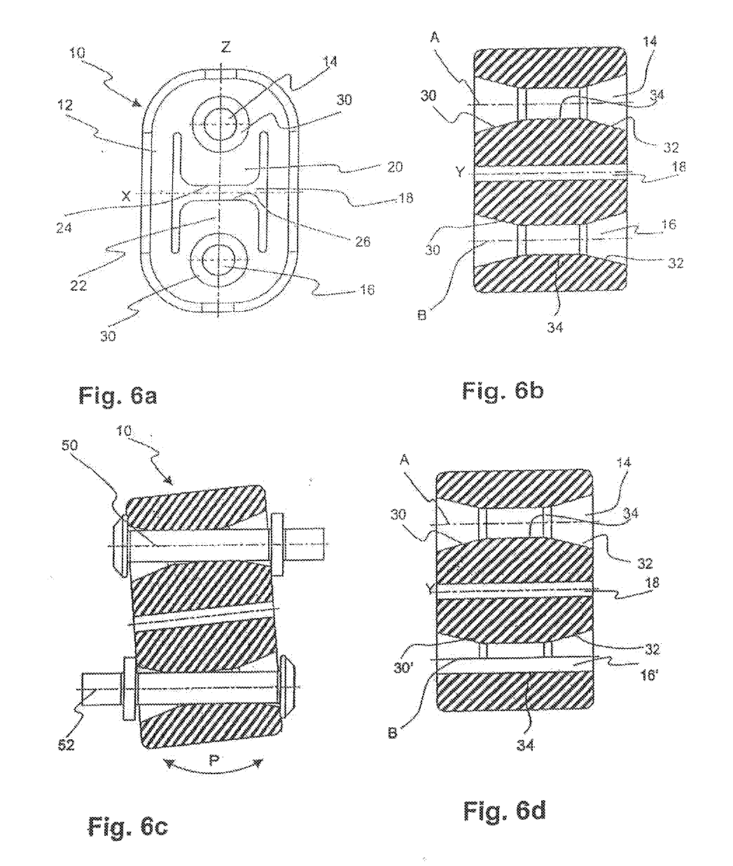

FIG. 6a shows a sixth embodiment of a device according to the invention, which differs in its basic geometry from the embodiments described above. Specifically, the elastomer body 12 is no longer designed with a rhombus shape, but is of rectangular shape with rounded corners. It has two receiving openings 14, 16 which again have two conical sections 30 and 32 at the ends. These sections are connected to one another via a substantially circular-cylindrical section 34. The central opening 18 is H-shaped in the front view according to FIG. 6a. The two buffers 20, 22 again have mutually opposite end faces 24, 26. The functioning as regards the pendulum movement is similar to that described above, as shown in FIG. 6c. The device 10 is attached to the suspending bolt 50 on the chassis side and carries an exhaust system via the suspending bolt 52. In the event of oscillations in the Y-direction, it is possible to perform a pendulum movement corresponding to the arrow P in accordance with the opening angles of the conical sections 30, 32, until finally a close contact occurs between the conical sections and the bolts 50, 52 which sets limits to a further pendulum movement with greater amplitude.

In the embodiment according to FIG. 6d, which shows a modification of the embodiment according to FIGS. 6a-6c, the lower opening 30′ and 16′ does not widen over the entire circumference. The lower region of the lower opening 30′ and 16′ has a circular-cylindrical lateral surface. As a result, in the event of a pivoting movement according to FIG. 6c, the bolt 52 comes into contact under great surface pressure with the corresponding cylindrical lateral surface of the receiving openings 16′ and 30′. In the arrangement shown, the lower cylindrical section extends over a region of 180°, viewed in the direction of the longitudinal axis B.

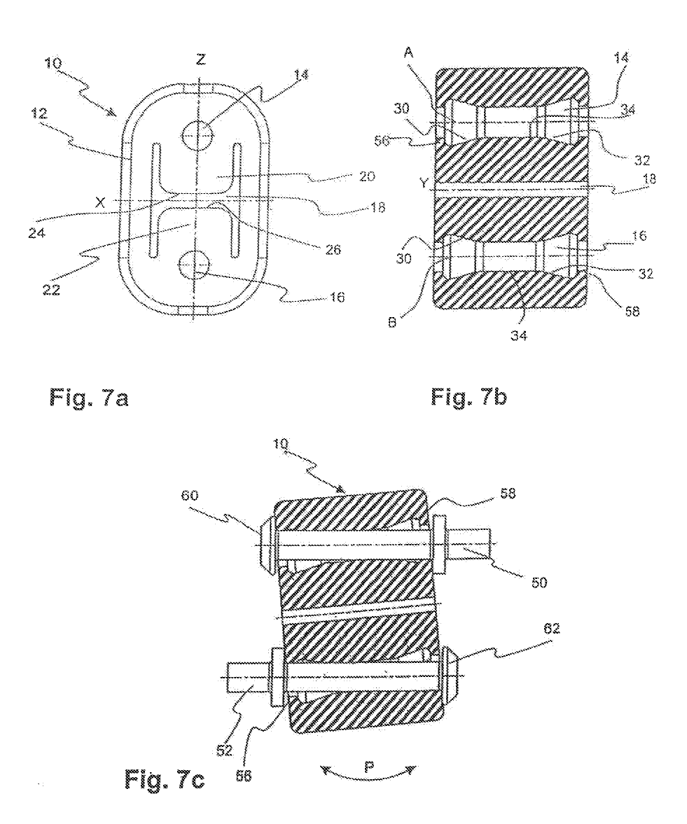

The embodiment according to FIG. 7a to FIG. 7c is similar to the embodiment according to 6a to 6c, but it differs in that the receiving openings 14 and 16 have diameter narrowings 56, 58 at the ends. These narrowings ensure that the bolts 50 and 52, which are each provided with a securing head 60, 62 at the end, do not run the risk of slipping out of the receiving openings 14 and 16 owing to the widening sections 30 and 32.

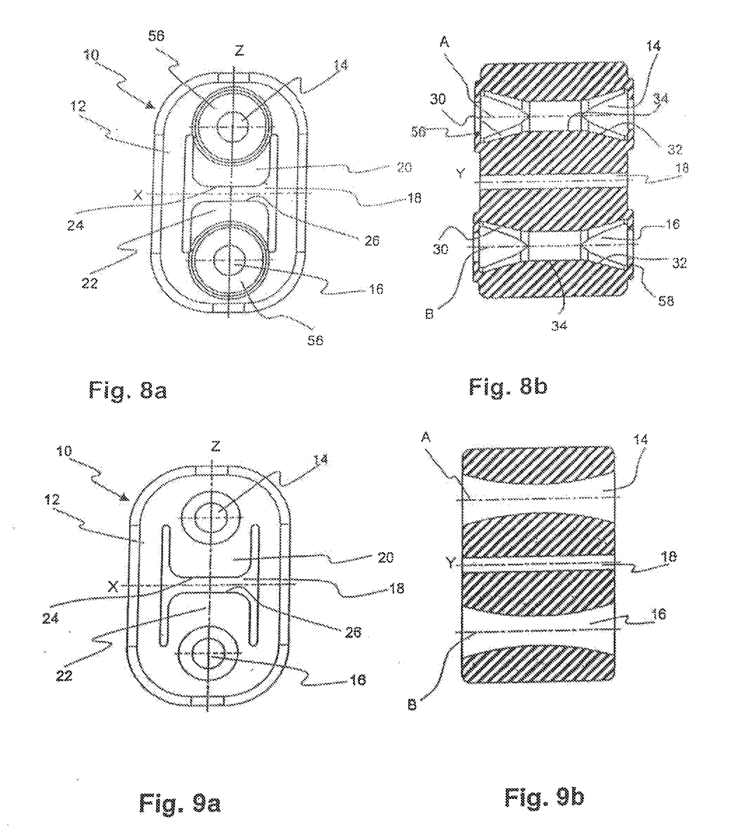

The embodiment according to FIGS. 8a and 8b differs from the embodiment according to FIGS. 7a to 7c in that the conical sections 30 and 32 are arranged merely in the upper and lower segment of the receiving openings 14 and 16, in a manner similar to that shown for example in FIGS. 3a to 3c, 4a, 4b and 5a to 5c. The contractions 56 are externally placed on the front and rear side of the respective elastomer body 12 by circular-cylindrical elevations. Otherwise, the embodiment according to FIGS. 8a and 8b corresponds to the embodiment according to FIGS. 7a to 7c.

The embodiment according to FIGS. 9a and 9b corresponds to the embodiment according to FIGS. 6a to 6c, with the receiving openings 14 and 16 having a harmonious rounded course with the lateral surface of a hyperboloid of revolution, instead of a sequence of conical section 30, cylindrical section 34 and conical section 32.

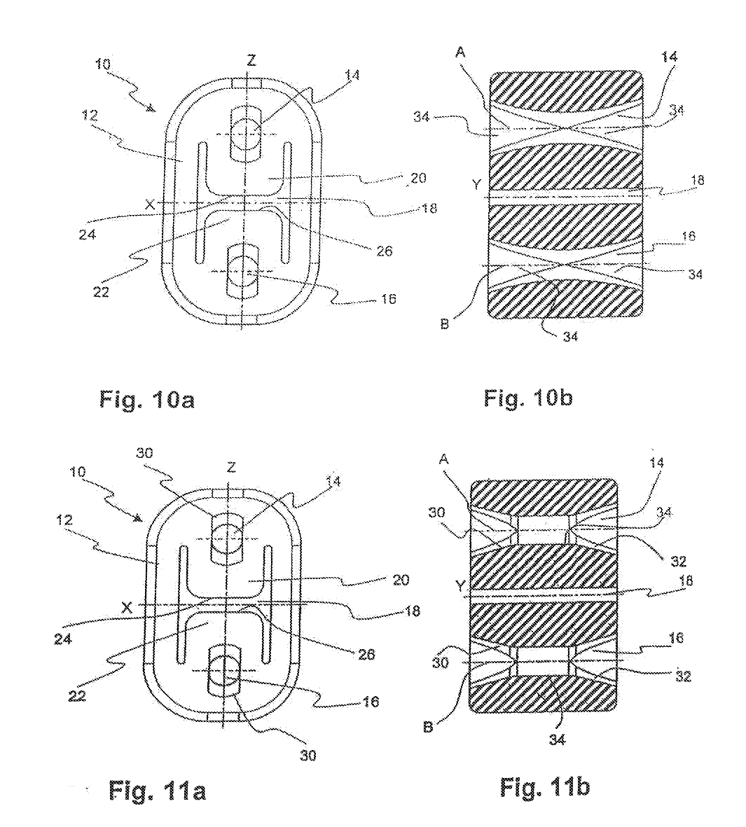

This also applies to the embodiment according to FIGS. 10a and 10b, with the lateral surface of a hyperboloid of revolution being provided merely in those segments of the receiving openings 14 and 16 which lie close to the Z-axis. In the lateral edge regions, the receiving openings 14 and 16 have the shape of circular-cylindrical lateral-surface sections.

The embodiment according to FIGS. 11a and 11b corresponds to the embodiment according to FIGS. 8a and 8b, with the externally placed contractions 56 and 58 having been omitted.

1. Device (10) for suspending an oscillating load, particularly for an exhaust system of a motor vehicle, having an elastomer body (12) which is of closed ring shape and has two receiving openings (14, 16) located opposite one another for receiving a respective elongate suspending bolt (50, 52) along a respective longitudinal axis (A, B) of the receiving openings (14, 16), the elastomer body (12) being designed for elastic deformation in the event of oscillations introduced via the receiving openings (14, 16),
characterised in that at least one of the receiving openings (14, 16) is designed with at least one section (30, 32) which widens with respect to the longitudinal axis towards the end of the receiving opening.

2. Device (10) according to claim 1, characterised in that the widening section (30, 32) is formed at least in sections by the lateral surface of a truncated cone, of a hyperboloid of revolution, of a paraboloid of revolution, or of a further body of revolution with respect to a revolution about the longitudinal axis (A, B) of the respective receiving opening (14, 16).

3. Device (10) according to claim 1 or 2, characterised in that the widening section (30, 32) has merely segmental widening regions, when viewed in the direction of the longitudinal axis (A, B) of the receiving opening.

4. Device (10) according to claim 3, characterised in that the widening segments (30, 32) are arranged, when viewed in the direction of the longitudinal axis (A, B) of the receiving opening, around a vertical axis running at right angles to the longitudinal axis (A, B) and running parallel with respect to a first reference plane containing both longitudinal axes (A, B) of the receiving openings (14, 16), or part of this reference plane.

5. Device (10) according to one of the preceding claims, characterised in that the at least one receiving opening (14, 16) is designed, at each of its two opposite ends, with a section (30, 32) widening in the direction of the longitudinal axis towards the respective end of the receiving opening (14, 16).

6. Device (10) according to claim 5, characterised in that a substantially circular-cylindrical section (34) running in the direction of the longitudinal axis (A, B) is provided between two widening sections (30, 32), arranged at the ends, of a receiving opening (14, 16).

7. Device (10) according to claim 6, characterised in that the transition between the at least one section (30, 32) widening towards the end of the receiving opening (14, 16) and the adjoining circular-cylindrical section (34) is of rounded design.

8. Device (10) according to one of the preceding claims, characterised in that the at least one section (30, 32) widening in the direction of the longitudinal axis (A, B) towards the end of the receiving opening (14, 16) is provided with a further diameter narrowing (56) at the end of the receiving opening (14, 16).

9. Device (10) according to one of the preceding claims, characterised in that at least one receiving opening (14, 16) is provided in the direction of the longitudinal axis (A, B) with longitudinal slots (42) arranged in the radially outer region of the device (10).

10. Device (10) according to one of the preceding claims, characterised in that the elastomer body (12) is reinforced with a reinforcing device (40).

11. Device (10) according to claim 10, characterised in that a flexible reinforcing insert, in particular at least one textile thread bundle (40), is embedded in the elastomer body (12).

12. Device (10) according to claim 10 or 11, characterised in that the elastomer body (12) is surrounded in its radially outer region by a reinforcing band or reinforcing ring.

13. Device (10) according to one of the preceding claims, characterised in that the elastomer body (12) has a central opening (18) radially within its region of closed ring shape, a pair of mutually facing buffers (20, 22) reaching into the central opening (18) and being arranged between the receiving openings (14, 16).

14. Device (10) according o claim 13, characterised in that each of the buffers (20, 22) respectively projects radially inwards from an edge region having one of the receiving openings (14, 16) and has an end face (24, 26) facing the respective other buffer (20, 22), each of the buffers (20, 22) being laterally connected to the region, of closed ring shape, of the elastomer body (12) via connecting regions (28).

15. Device (10) according to claim 14, characterised in that the connecting regions (28) have, at least in sections, a wall thickness reduced in relation to the region, of closed ring shape, of the elastomer body (12).
